(19) United States
(12) Patent Application Publication
(10) Pub. No.: US 2004/0209641 A1
(43) Pub. Date: Oct. 21, 2004

(54) Double folder mobile phone

(76) Inventor: Choong-Sheek Hong, Yongin-si (KR)

Correspondence Address: McGuireWoods LLP, Tysons Corner, Suite 1800, 1750 Tysons Boulevard, McLean, VA, 22102-4215, US

(21) Appl. No.: 10/654,405

(22) Filed: Sep. 4, 2003

(30) Foreign Application Priority Data
Apr. 21, 2003 (KR) KR10-2003-0025049

(51) Int. Cl. H04M 1/00

(52) U.S. Cl. 455/550.1; 455/575.3

(57) ABSTRACT

A double folder mobile phone provides game and multimedia services through stereophonic sound. The double folder mobile phone includes a main body provided with a display at the front to provide an image to a user, an upper folder connected with an upper part of the main body by a hinge, having a plurality of buttons and a speaker, and a lower folder connected with a lower part of the main body by a hinge, having a plurality of buttons and a speaker. The user can enjoy stereo sound when using game or multimedia services, thereby maximizing reality.

### BACKGROUND OF THE INVENTION

1. Field of the Invention

The present invention relates to a double folder mobile phone, and more particularly to a double folder mobile phone that can provide game and multimedia services through stereo sound.

2. Discussion of the Related Art

Recently, it is a general tendency that mobile phone users want to use multimedia services such as various games and bell sound. A related art mobile phone, as shown in FIG. 1, includes a main body 10 and a folder 20. The main body 10 is provided with various buttons 11, and a mike 12 is built in the lower part of the main body 10. The folder 20 is provided with a display 21 and a receiving part 22. The related art mobile phone has a structure that a user is to recognize a ring signal through a speaker 14 provided at a side of the main body 10. That is, in the related art mobile phone, the user can be given sound through only a speaker when enjoying games or other multimedia services. In this case, stereo sound cannot be provided to the user. This reduces reality in game and multimedia services.

### SUMMARY OF THE INVENTION

The present invention is directed to a double folder mobile phone substantially obviates one or more of the problems due to limitations and disadvantages of the related art.

An object of the present invention is to provide a double folder mobile phone in which upper and lower folders provided on a main body are connected with each other by a hinge to fold and unfold and are respectively provided with a speaker to provide real stereo sound for games and multimedia services.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, a double folder mobile phone according to the present invention includes a main body provided with a display at the front to provide an image to a user, an upper folder connected with an upper part of the main body by a hinge, having a plurality of buttons and a speaker, and a lower folder connected with a lower part of the main body by a hinge, having a plurality of buttons and a speaker.

Preferably, the upper folder is provided with a mike on its inner corner so as not to cause any inconvenience during calling.

A switch is provided at a side of the main body and is connected with a motor provided on the hinge of the upper and lower folders to automatically fold and unfold the upper and lower folders.

Sound volume in the speaker of the upper folder is automatically adjusted.

An auxiliary display is provided on the outer side of the upper folder.

A touch panel is provided in the display of the main body to substitute for buttons, and a camera is provided on the outer side of the upper folder.

It is to be understood that both the foregoing general description and the following detailed description are exemplary and explanatory and are intended to provide further explanation of the invention as claimed.

### BRIEF DESCRIPTION OF THE ATTACHED DRAWINGS

The invention will be described in detail with reference to the following drawings in which like reference numerals refer to like elements wherein:

FIG. 1 is a perspective view illustrating a related art folder type mobile phone;

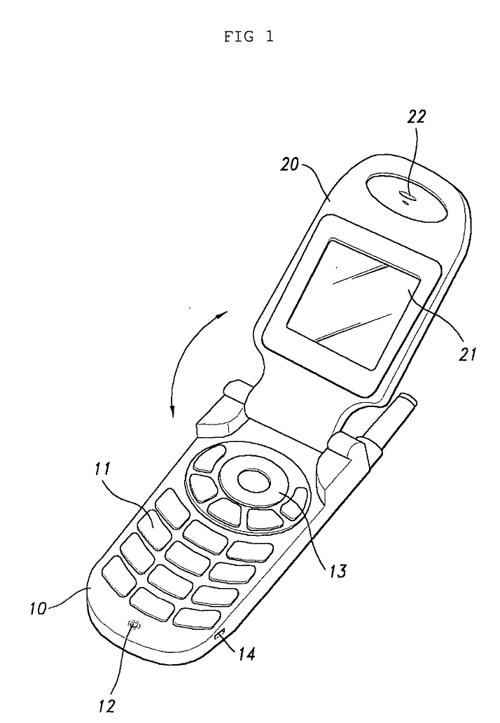

FIG. 2 is a perspective view illustrating a double folder mobile phone according to the present invention;

FIG. 3 is a perspective view illustrating the state that upper and lower folders of a double folder mobile phone according to the present invention are unfolded;

FIG. 4 is a front view illustrating the state that upper and lower folders of a double folder mobile phone according to the present invention are unfolded;

FIG. 5 is a right side view illustrating an antenna built in a double folder mobile phone according to the present invention, which is marked by a solid line;

FIG. 6 is a right side view illustrating the state that upper and lower folders of a double folder mobile phone according to the present invention are unfolded; and

FIG. 7 is a rear view illustrating the state that upper and lower folders of a double folder mobile phone according to the present invention are unfolded.

### DETAILED DESCRIPTION OF THE PREFERRED EMBODIMENTS

Reference will now be made in detail to the preferred embodiments of the present invention, examples of which are illustrated in the accompanying drawings.

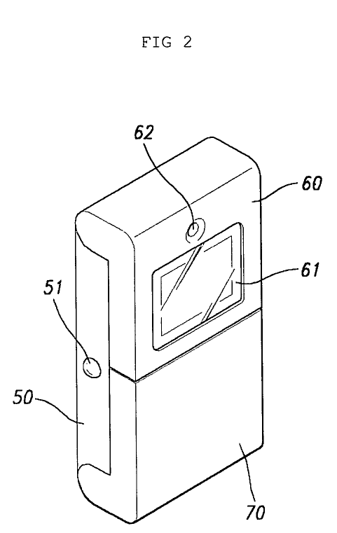

A double folder mobile phone according to the present invention will be described with reference to FIG. 2.

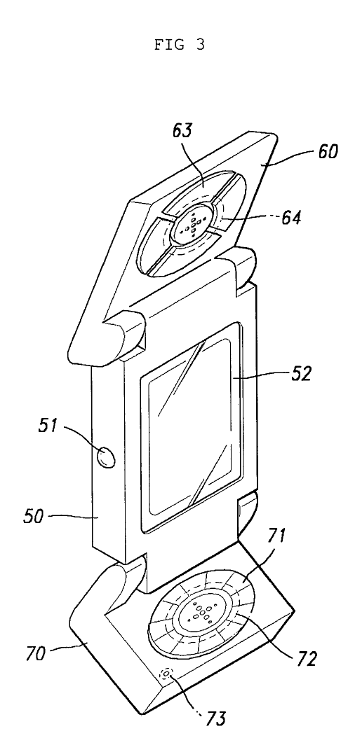

As shown in FIG. 2, the double folder mobile phone includes a main body 50, an upper folder 60, and a lower folder 70. The upper folder 60 is connected with an upper part of the main body 50 by a hinge while the lower folder 70 is connected with a lower part of the main body 50 by a hinge, so that the upper and lower folders 60 and 70 are folded or unfolded as shown in FIG. 3. The main body 50 is provided with a button 51 at a side. The button 51 serves to automatically fold and unfold the upper and lower folders 60 and 70. Once the button 51 is pushed, a motor (not shown) provided on the hinge of the upper and lower folders 60 and 70 is operated to fold and unfold them. An auxiliary display 61 is provided on the front of the upper folder 60 and displays received simple information such as phone numbers, date, and time, so that the user can catch such information even in a state that the user does not unfold the upper and lower folders 60 and 70. A small sized camera 62 is provided on the upper part of the auxiliary display 61 of the upper folder 60. The user can operate the camera 62 by pushing a button 71 of the lower folder 70 while viewing the display 52 in a state that the upper and lower folders are unfolded. Also, the camera may be operated using buttons 63 of the upper folder 60. Alternatively, a button may be provided at the side of the main body 50 to operate the camera 62.

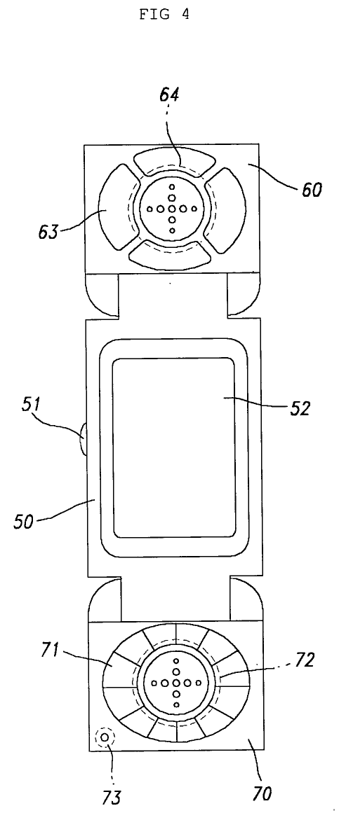

FIGS. 3 and 4 are perspective and front views showing the state that the double folder mobile phone according to the present invention is unfolded.

Referring to FIGS. 3 and 4, a speaker 64 is built in the upper folder 60 and directional buttons 63 are provided around the speaker 64. A large sized display 52 is provided on the front of the main body 50 to display various information in images. Such images are displayed even in a state that the user uses games or other multimedia services. Also, the display 52 may additionally be provided with a touch panel to substitute for the button. Number buttons 71 for dialing are provided on the lower folder 70. The number buttons 71 may be used as those for games when the user enjoys the games. A speaker 72 is built in the center of the number buttons 71.

Therefore, the user can be given real service such as stereo sound through the speakers 64 and 72 when enjoying games or viewing multimedia services. In case that the user receives a call, the speaker 64 of the upper folder 60 may be used as a receiving part and a mike 73 provided on the corner inside the lower folder 70 is used as a transmitting part.

Since the speaker 64 of the upper folder 60 is used as both the receiving part and a speaker for game and multimedia services, its sound volume is automatically adjusted to protect the sense of hearing of the user.

As described above, the user can carry the aforementioned double folder mobile phone in a state that the upper and lower folders 60 and 70 are folded as shown in FIG. 2. In case of receiving a call, the user pushes the button 51 at the side of the main body 50 so that the upper and lower folders 60 and 70 are unfolded and then tries calling using the speaker 64 of the upper folder 60 and the mike 73 of the lower folder 73.

Meanwhile, for game or multimedia services, the user pushes the button 51 of the main body 50 to unfold the upper and lower folders 60 and 70 and then pushes various buttons 63 and 71 provided inside the folders 60 and 70. In this case, the user views the image of game or multimedia services currently in service through the display 52 of the main body 50 and at the same time hears stereo sound through the speakers 64 and 72 of the folders 60 and 70. Thus, the user enjoys the services along with more enhanced reality.

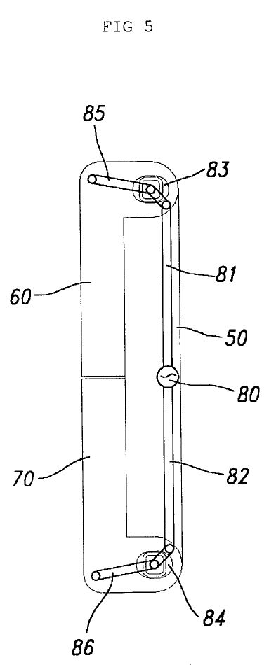

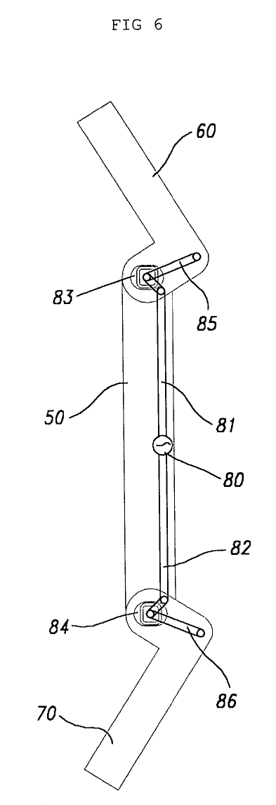

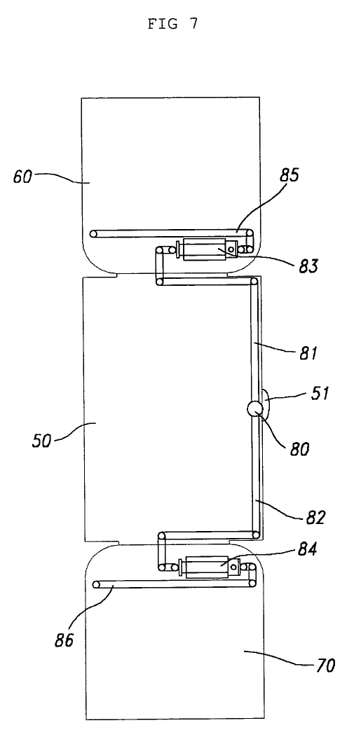

FIGS. 5 to 7 illustrate a built-in antenna of the double folder mobile phone according to the present invention. As shown, a modified dipole antenna having upper and lower parts is provided at a feed point 80. A first upper radial 81 and a second upper radial 85 are provided at the upper part. The first upper radial 81 is disposed in the main body 50 and the second upper radial 80 is disposed in the upper folder 60. The first upper radial 81 is connected with the second upper radial 85 by an upper hinge 83. Likewise, a first lower radial 82 and a second lower radial 86 are provided at the lower part. The first lower radial 82 is disposed in the main body 50 and the second lower radial 86 is disposed in the lower folder 70. The first lower radial 82 is connected with the second lower radial 84 by a lower hinge 84. The dipole antenna constructed as above has a maximized radial area in which electric field equal to the whole size of the main body 50 can be distributed even in case that the folder is folded.

As aforementioned, the double folder mobile phone according to the present invention has the following advantages.

Since the upper and lower folders each having a speaker are connected with each other by a hinge to fold and unfold, the user can enjoy stereo sound when using game or multimedia services, thereby maximizing reality.

In addition, since a built-in type antenna is provided, a compact design along with aesthetic appearance can be realized.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A double folder mobile phone comprising:
a main body provided with a display at the front to provide an image to a user;
an upper folder connected with an upper part of the main body by a hinge, having a plurality of buttons and a speaker; and
a lower folder connected with a lower part of the main body by a hinge, having a plurality of buttons and a speaker.

2. The double folder mobile phone according to claim 1, further comprising a switch provided at a side of the main body, wherein the switch is connected with a motor provided on the hinge of the upper and lower folders to automatically fold and unfold the upper and lower folders.

3. The double folder mobile phone according to claim 1, wherein sound volume in the speaker of the upper folder is automatically adjusted.

4. The double folder mobile phone according to claim 1, further comprising an auxiliary display provided on the outer side of the upper folder.

5. The double folder mobile phone according to claim 1, further comprising a camera provided on the outer side of the upper folder.

6. The double folder mobile phone according to claim 1, further comprising an antenna having a radial area maximized by the hinge.
